(19) United States
(12) Patent Application Publication
(10) Pub. No.: US 2014/0076928 A1
(43) Pub. Date: Mar. 20, 2014

(54) MATERIAL COMPOSITION, LAMINATE TUBE AND METHOD FOR MANUFACTURE THEREOF

(71) Applicant: Mrinal Kanti Banerjee, Mumbai (IN)

(72) Inventor: Mrinal Kanti Banerjee, Mumbai (IN)

(73) Assignee: ESSEL PROPACK LTD., Mumbai (IN)

(21) Appl. No.: 14/117,829

(22) PCT Filed: Jun. 4, 2012
(86) PCT No.: PCT/IN2012/000390

§ 371 Date: Nov. 14, 2013

(30) Foreign Application Priority Data
Jun. 6, 2011 (IN) 164/MUM/2011

(51) Int. Cl. B65D 35/14; B32B 1/08

(52) U.S. Cl. CPC B65D 35/14; B32B 1/08
USPC 222/107; 525/57

(57) ABSTRACT

The present disclosure relates to a material composition comprising: a High Density Polyethylene; Ethylene Vinyl Alcohol; and at least one compatibilizer; wherein the material composition comprises flake-shaped particles. The present disclosure further relates to a laminate tube comprising: a body portion; a neck portion; and a tube shoulder; wherein the tube shoulder is made up of a material composition comprising: a High Density Polyethylene; Ethylene Vinyl Alcohol; and at least one compatibilizer; wherein the material composition comprises flake-shaped particles. The present disclosure also relates to a tube shoulder made up of a material composition comprising: a High Density Polyethylene; Ethylene Vinyl Alcohol; and at least one compatibilizer; wherein the material composition comprises flake-shaped particles. The present disclosure further relates to a process for preparing a material composition comprising: compounding a High Density Polyethylene, Ethylene Vinyl Alcohol, and at least one compatibilizer in a twin screw extruder to obtain the material composition; wherein the material composition comprises flake-shaped particles.

### TECHNICAL FIELD

The present disclosure relates to a material composition suitable for making shoulder for laminate tubes, or body of tubes; a tube shoulder thereof and a laminate tube with said tube shoulder; and a method of manufacture of such material composition and tube shoulders. The material composition of the present disclosure gives improved barrier properties to the tube shoulder.

### BACKGROUND

A tube is a soft squeezable container used for packaging thick liquids, such as toothpaste, lotions, creams, gels, and like. Additionally, such packaging tubes need to preserve properties of their contents. For this purpose, a laminate material can be used to manufacture the packaging tubes, such as laminate tubes. The laminate material is a composite material which forms a tube body of the laminate tube. The laminate material usually consists of several polymer layers with a barrier layer embedded in between. This barrier layer restricts the passage of gas, vapour, aroma, etc. though the tube body. In this way, the tube body can be molded into the multi-layered structure having desired barrier properties.

In laminate tubes, unlike aluminum tubes, which are extruded from one piece, a tube shoulder must be made separately and attached to the tube body. Sometimes a preformed shoulder is fed to the laminate tube on a mandrel and then fused to the top edge of the tube body. Other options are to use injection or compression molding to fuse the shoulder to the tube body. Unlike the tube body, the tube shoulder cannot be easily molded into the multi-layered structure due to its complicated shape and its separate manufacturing process. The tube shoulder usually does not have desired barrier properties, and thus protection of the contents inside the laminate tube is difficult due to passage of oxygen, moisture, aroma, flavour, etc. through the tube shoulder.

U.S. Pat. No. 5,372,863 discloses a laminate tube container having a shoulder with improved barrier properties in that the shoulder comprises a material composed of (A) 0 to 50% by weight of polyethylene, (B) 10 to 50% by weight of an ethylene-vinyl alcohol co-polymer and (C) 10 to 90% by weight of a carboxylic acid-modified adhesive polyethylene resin. The laminate tube is useful as containers used for toothpaste, medicine, drinks and adhesive. However, the polyethylene content of the laminate is less which did not impart good barrier properties, further the arrangement of ethylene-vinyl alcohol in polyethylene is regular, which further deteriorate the barrier properties of the laminate

Hence, there is a need for a material for shoulder of tube laminates with improved barrier properties.

### SUMMARY

This summary is provided to introduce concepts related to a laminate tube having improved barrier properties. The composition can be used in tube shoulder or tube body. The summary also provides a method of manufacturing such tube shoulders, which are further described below in the detailed description.

The present disclosure relates to a material composition comprising: 50% to 60% (w/w) of a High Density Polyethylene (HDPE); 30% to 40% (w/w) of Ethylene Vinyl Alcohol (EVOH); and 10% to 20% (w/w) of at least one compatibilizer, wherein the material composition comprises of flake-shaped particles.

The present disclosure further relates to a laminate tube comprising: a body portion; a neck portion; and a tube shoulder; wherein the tube shoulder is made up of a material composition comprising: 50% to 60% (w/w) of a High Density Polyethylene (HDPE); 30% to 40% (w/w) of Ethylene Vinyl Alcohol (EVOH); and 10% to 20% (w/w) of at least one compatibilizer, wherein the material composition comprises of flake-shaped particles.

The present disclosure also relates to a process for preparing a material composition comprising: compounding 50% to 60% (w/w) of a High Density Polyethylene (HDPE), 30% to 40% (w/w) of Ethylene Vinyl Alcohol (EVOH), and 10% to 20% (w/w) of at least one compatibilizer in a twin screw extruder to obtain the material composition; wherein the material composition comprises flake-shaped particles.

The present disclosure further relates to a tube shoulder made up of a material composition comprising: 50% to 60% (w/w) of a High Density Polyethylene (HDPE); 30% to 40% (w/w) of Ethylene Vinyl Alcohol (EVOH); and 10% to 20% (w/w) of at least one compatibilizer, wherein the material composition comprises of flake-shaped particles.

These and other features, aspects, and advantages of the present subject matter will become better understood with reference to the following description. This statement is provided to introduce a selection of concepts in a simplified form. This statement is not intended to identify key features or essential features of the subject matter, nor is it intended to be used to limit the scope of the subject matter.

### DETAILED DESCRIPTION

The present disclosure provides a material composition comprising: 50% to 60% (w/w) of a High Density Polyethylene (HDPE); 30% to 40% (w/w) of Ethylene Vinyl Alcohol (EVOH); and 10% to 20% (w/w) of at least one compatibilizer; wherein the material composition comprises flake-shaped particles.

A tube shoulder made up of a material composition of the present disclosure have improved barrier properties as compared with tube shoulders made of conventional material compositions. In addition, the material composition of the present disclosure also provides improved adhesion qualities for attaching the tube shoulder to the body portion of the laminate tube.

The material composition of the present disclosure comprises particles with flake-shaped forms before preparing a tube shoulder. Preferably, the ingredients of the composition are compounded to obtain the flake-shaped particles. The term ‘flake-shaped particles’ denote flat thin pieces or chips. In the present context, the terms ‘flake-shaped particles’, “platelets” or “pellets” are used interchangeably and is intended to specify the same meaning.

Such platelets can be used directly in making of a tube shoulder with Compression molding technique. In the tube shoulder made from said technique, Ethylene Vinyl Alcohol crystals are haphazardly orientated in form of ‘platelets’ or ‘flake-shaped particle’ inside the HDPE body. Because of the Compression molded technique, the ‘platelets’ formation inside the High Density Polyethylene body is very random and therefore, it creates a disordered or an irregular structure in the HDPE body. Such irregular structure obtained in the body provides a difficult path for the flavor in the content of the tube with such shoulder, to pass through. By the time flavor molecule reach the other side of the molded tube shoulder, designated shelf life is achieved. The enhancement of the barrier property is hence seen with the composition of the present disclosure.

Another embodiment of the present disclosure provides a material composition comprising: 50% to 60% (w/w) of a High Density Polyethylene (HDPE); 30% to 40% (w/w) of Ethylene Vinyl Alcohol (EVOH); and 10% to 20% (w/w) of a maleic anhydride copolymer; wherein the material composition comprises flake-shaped particles.

Yet another embodiment of the present disclosure provides a material composition comprising: 50% to 60% (w/w) of a High Density Polyethylene (HDPE); 30% to 40% (w/w) of Ethylene Vinyl Alcohol (EVOH); and 10% to 20% (w/w) of an ionomer; wherein the material composition comprises flake-shaped particles.

The HDPE used in the material composition of the present disclosure has a density in the range of 0.94 to 0.96 and Melt flow index in the range of 1.0 to 3.0. In accordance with the present disclosure, the HDPE used in the material composition of the present disclosure can be notably commercially available polymer such as Basell's “GD4755”.

The EVOH used in the material composition of the present disclosure has ethylene mol percentage of 32 and Melt flow Ratio (MFR) in the range of 1.5 to 3.0. In accordance with the present disclosure, the EVOH can be notably commercially available, such as “F171” from Kuraray corp.

The expression “at least one compatibilizer” is understood to mean that one or more than one compatibilizer can be used in the composition of the present disclosure.

The compatibilizer used in the material composition of the present disclosure, could be selected from an Ionomer, Maleic Anhydride Copolymer. Notably commercially available compatibizers readily available from Dow Chemicals or DuPont chemicals can be used. Since HDPE and EVOH are immiscible polymers, the compatibilizer modifies the interfaces of the HDPE polymer and EVOH polymer and stabilizes the blend. The ionomers used in the present disclosure are commercially available ionomers such as but not limited to ‘Surlyn’ from Dupont or ‘Iotek’ from ExxonMobil.

The present disclosure also provides a laminate tube comprising: a body portion; a neck portion; and a tube shoulder; wherein the tube shoulder is made up of a material composition comprising: 50% to 60% (w/w) of a High Density Polyethylene (HDPE); 30% to 40% (w/w) of Ethylene Vinyl Alcohol (EVOH); and 10% to 20% (w/w) of at least one compatibilizer; wherein the material composition comprises flake-shaped particles.

Another embodiment of the present disclosure provides a laminate tube comprising: a body portion; a neck portion; and a tube shoulder; wherein the tube shoulder is made up of a material composition comprising: 50% to 60% (w/w) of a High Density Polyethylene (HDPE); 30% to 40% (w/w) of Ethylene Vinyl Alcohol (EVOH); and 10% to 20% (w/w) of a maleic anhydride copolymer; wherein the material composition comprises flake-shaped particles.

Further, an embodiment of the present disclosure provides a laminate tube comprising: a body portion; a neck portion; and a tube shoulder; wherein the tube shoulder is made up of a material composition comprising: 50% to 60% (w/w) of a High Density Polyethylene (HDPE); 30% to 40% (w/w) of Ethylene Vinyl Alcohol (EVOH); and 10% to 20% (w/w) of an ionomer; wherein the material composition comprises flake-shaped particles.

An embodiment of the present disclosure provides a laminate tube comprising: a body portion; a neck portion; and a tube shoulder; wherein the tube shoulder and the body portion are made up of a material composition comprising: 50% to 60% (w/w) of a High Density Polyethylene (HDPE); 30% to 40% (w/w) of Ethylene Vinyl Alcohol (EVOH); and 10% to 20% (w/w) of at least one compatibilizer; wherein the material composition comprises flake-shaped particles.

Still another embodiment of the present disclosure provides a laminate tube comprising: a body portion; a neck portion; and a tube shoulder; wherein the tube shoulder and the body portion are made up of a material composition comprising: 50% to 60% (w/w) of a High Density Polyethylene (HDPE); 30% to 40% (w/w) of Ethylene Vinyl Alcohol (EVOH); and 10% to 20% (w/w) of a maleic anhydride copolymer; wherein the material composition comprises flake-shaped particles.

Another embodiment of the present disclosure provides a laminate tube comprising: a body portion; a neck portion; and a tube shoulder; wherein the tube shoulder and the body portion are made up of a material composition comprising: 50% to 60% (w/w) of a High Density Polyethylene (HDPE); 30% to 40% (w/w) of Ethylene Vinyl Alcohol (EVOH); and 10% to 20% (w/w) of an ionomer; wherein the material composition comprises flake-shaped particles.

Yet another embodiment of the present disclosure provides a laminate tube comprising: a body portion; a neck portion; and a tube shoulder; wherein the tube shoulder and the neck portion are made up of a material composition comprising: 50% to 60% (w/w) of a High Density Polyethylene (HDPE); 30% to 40% (w/w) of Ethylene Vinyl Alcohol (EVOH); and 10% to 20% (w/w) of at least one compatibilizer; wherein the material composition comprises flake-shaped particles.

Still another embodiment of the present disclosure provides a laminate tube comprising: a body portion; a neck portion; and a tube shoulder; wherein the tube shoulder and the neck portion are made up of a material composition comprising: 50% to 60% (w/w) of a High Density Polyethylene (HDPE); 30% to 40% (w/w) of Ethylene Vinyl Alcohol (EVOH); and 10% to 20% (w/w) of a maleic anhydride copolymer; wherein the material composition comprises flake-shaped particles.

Further, an embodiment of the present disclosure provides a laminate tube comprising: a body portion; a neck portion; and a tube shoulder; wherein the tube shoulder and the neck portion are made up of a material composition comprising: 50% to 60% (w/w) of a High Density Polyethylene (HDPE); 30% to 40% (w/w) of Ethylene Vinyl Alcohol (EVOH); and 10% to 20% (w/w) of an ionomer; wherein the material composition comprises flake-shaped particles.

Still another embodiment of the present disclosure provides a laminate tube comprising: a body portion; a neck portion; and a tube shoulder; wherein the tube shoulder, the body portion and the neck portion are made up of a material composition comprising: 50% to 60% (w/w) of a High Density Polyethylene (HDPE); 30% to 40% (w/w) of Ethylene Vinyl Alcohol (EVOH); and 10% to 20% (w/w) of at least one compatibilizer; wherein the material composition comprises flake-shaped particles.

Yet another embodiment of the present disclosure provides a laminate tube comprising: a body portion; a neck portion; and a tube shoulder; wherein the tube shoulder, the body portion and the neck portion are made up of a material composition comprising: 50% to 60% (w/w) of a High Density Polyethylene (HDPE); 30% to 40% (w/w) of Ethylene Vinyl Alcohol (EVOH); and 10% to 20% (w/w) of a maleic anhydride copolymer; wherein the material composition comprises flake-shaped particles.

Still, another embodiment of the present disclosure provides a laminate tube comprising: a body portion; a neck portion; and a tube shoulder; wherein the tube shoulder, the body portion and the neck portion are made up of a material composition comprising: 50% to 60% (w/w) of a High Density Polyethylene (HDPE); 30% to 40% (w/w) of Ethylene Vinyl Alcohol (EVOH); and 10% to 20% (w/w) of an ionomer; wherein the material composition comprises flake-shaped particles.

In an embodiment the whole of the laminate tube may be made up of the material composition of the present disclosure.

An embodiment of the present disclosure provides a tube shoulder made up of a material composition comprising: 50% to 60% (w/w) of a High Density Polyethylene (HDPE); 30% to 40% (w/w) of Ethylene Vinyl Alcohol (EVOH); and 10% to 20% (w/w) of at least one compatibilizer; wherein the material composition comprises flake-shaped particles.

Another embodiment of the present disclosure provides a tube shoulder made up of a material composition comprising: 50% to 60% (w/w) of a High Density Polyethylene (HDPE); 30% to 40% (w/w) of Ethylene Vinyl Alcohol (EVOH); and 10% to 20% (w/w) of a maleic anhydride copolymer; wherein the material composition comprises flake-shaped particles.

Yet, another embodiment of the present disclosure provides a tube shoulder made up of a material composition comprising: 50% to 60% (w/w) of a High Density Polyethylene (HDPE); 30% to 40% (w/w) of Ethylene Vinyl Alcohol (EVOH); and 10% to 20% (w/w) of an ionomer; wherein the material composition comprises flake-shaped particles.

In an embodiment the tube shoulder of the laminate tube of the present disclosure comprises an inner barrier liner which is mounted internally in the tube shoulder.

The inner barrier liner of the present disclosure comprising of: at least one polyolefin layer made up of simple olefin selected from polyethylene or polypropylene; at least one barrier layer made up of a material selected from aluminium foil or EVOH; and at least one tie layer made up of a material selected from a acid copolymer or maleic anhydride grafted copolymer present between the polyolefin layer and the barrier layer.

The polyolefin layer of the inner barrier liner of the present disclosure has a thickness in the range of 40 microns to 100 microns.

The barrier layer of the inner barrier liner of the present disclosure has a thickness in the range of 10 to 25 microns.

The tie layer of the inner barrier liner of the present disclosure has a thickness in the range of In an embodiment of the present disclosure the inner liner comprising of: an outer polyolefin layer having thickness of 40 microns; a barrier layer having thickness of 20 microns; a first tie layer binding the outer polyolefin layer and the barrier layer, having thickness of 25 microns; an inner polyolefin layer having thickness of 50 microns; and a second tie layer binding the inner polyolefin layer and the barrier layer, having thickness of 25 microns.

The inner barrier liner is in the form of a washer which is mounted internally on a conventional polymer layer, such as a high-density polyethylene (HDPE) layer, of a conventional tube shoulder. The inner barrier liner consists of polymer layers with a barrier layer inserted in between. The barrier layer includes barrier properties against passage of aroma, flavor, oxygen, moisture, and like. Additionally, the barrier layer may offer chemical resistivity against the contents packaged inside the laminate tube. The barrier layer can be made of different materials, e.g., EVOH or aluminum foil, having desired barrier properties.

The inner barrier liner comprising of an asymmetrical combination of (A) polyolefin, (B) aluminum foil or EVOH, and (C) copolymers tie extrusion layer.

Component A i.e., polyolefin is a polymer produced from a simple olefin (also called an alkene with the general formula CₙH₂ₙ) as a monomer. For example, polyethylene is the polyolefin produced by polymerizing the olefin ethylene. Polypropylene is another common polyolefin which is made from the olefin propylene.

Component B, a barrier layer, when EVOH, prevents a product to diffuse from the laminate tube. In addition, it prevents substances from outside to diffuse into the laminate tube and to change or spoil the product by reacting with it. EVOH offers good barrier properties for all common products like cosmetics creams or gels, food products, household chemicals, technical filling goods and oral care products. As an alternative to EVOH, aluminum can be used as the barrier in some laminates. Since aluminum offers the highest barrier quality, it is therefore suitable primarily for very aggressive and highly reactive filling goods, like depilatories or shaving creams, silicones, OTC products and perishable food.

Component C, i.e., copolymers tie extrusion layer, such as Acid copolymer or Maleic anhydride grafted copolymer. This layer serves as the binding layer between the component A and the component B. In this way, choice of component C may depend upon the component A and the component B.

The inner barrier liner in the tube shoulder, in accordance with the present disclosure, can be made in a separate process employing an extrusion lamination technique. Layer positioning of Inner barrier liner is such that the barrier layer, such as Aluminium foil or EVOH, always remain the central layer followed by copolymer TIE extrusion layer on either side of the barrier layer, and then Polyolefin layer as an outer and inner most skin layer. Thickness wise layer configuration of a 5 layer inner barrier liner comprising is indicated in Table 1 below:

TABLE 1

| Layer | Material | Thickness (microns) |
|---|---|---|
| Outer skin layer | Polyethylene | 40 |
| TIE layer | Acid copolymer or Maleic | 25 |
| | anhydride grafted copolymer | |
| Barrier layer | Aluminium foil or EVOH | 20 |
| TIE layer | Acid copolymer or Maleic | 25 |
| | anhydride grafted copolymer | |
| Inner skin layer | Polyethylene | 50 |
| (product contact layer) | | |

The present disclosure further relates to a process for preparing a material composition comprising: compounding 50% to 60% (w/w) of a High Density Polyethylene (HDPE), 30% to 40% (w/w) of Ethylene Vinyl Alcohol (EVOH), and 10% to 20% (w/w) of at least one compatibilizer in a twin screw extruder to obtain the material composition; wherein the material composition comprises flake-shaped particles.

A tube shoulder according to the present disclosure can be manufactured by a method comprising: processing pre-blended material composition of High density polyethylene, Ethylene vinyl alcohol and compatibilizer in a barrier screw extruder with 24:1, screw Length by Diameter (L/D) ratio to obtain plasticized material composition melt; dosing the plasticized material composition melt in the form of a donut, on to a specific shaped shoulder mould; the shoulder mould along with the donut moves to the next indexing station where the tube sleeve, mounted on to a steel mandrel is combined together and compressed to form the specific shoulder shape including the threaded neck portion and orifice. During said compression, specific heat from the polymer melt or donut gets fused with the inner sealant layer of the tube sleeve.

As described hereinbefore, the tube shoulder according to the present disclosure is markedly improved in barrier properties and adhesion to the tube body. Accordingly, the quality of the contents of the laminate tube can be maintained for a long period of time and, further, the quality assurance period by a manufacturer, is greatly extended without the release of aroma or volatile components through the shoulder or cause of any change in the quality of the contents. Consequently, a laminate tube having a tube shoulder according to the present disclosure is extremely useful to be used for toothpaste, medicine, food, drinks, adhesives or the like.

The tube shoulder may be molded by a general molding method including extrusion molding, compression molding and injection molding. Further, the prepared tube Shoulder is bonded to a separately prepared tube body to complete a tube container.

While certain features of the claimed subject matter have been illustrated and described herein, many modifications, substitutions, changes, and equivalents will now occur to those skilled in the art.

### EXAMPLES

The following examples are given by way of illustration of the present invention and should not be construed to limit the scope of present disclosure. It is to be understood that both the foregoing general description and the following detailed description are exemplary and explanatory only and are intended to provide further explanation of the claimed subject matter.

### Example 1

50% (w/w) of a High Density Polyethylene (HDPE), 40% (w/w) of Ethylene Vinyl Alcohol (EVOH), and 10% (w/w) of a maleic anhydride copolymer has been compounded in a twin screw extruder to obtain the compounded material composition in a pellet shape.

### Example 2

50% (w/w) of a High Density Polyethylene (HDPE), 40% (w/w) of Ethylene Vinyl Alcohol (EVOH), and 10% (w/w) of an ionomer has been compounded in a twin screw extruder to obtain the compounded material composition in a pellet shape.

### Example 3

60% (w/w) of a High Density Polyethylene (HDPE), 30% (w/w) of Ethylene Vinyl Alcohol (EVOH), and 10% (w/w) of a maleic anhydride copolymer has been compounded in a twin screw extruder to obtain the compounded material composition in a pellet shape.

### Example 4

60% (w/w) of a High Density Polyethylene (HDPE), 30% (w/w) of Ethylene Vinyl Alcohol (EVOH), and 10% (w/w) of an ionomer has been compounded in a twin screw extruder to obtain the compounded material composition in a pellet shape

### Example 5

50% (w/w) of a High Density Polyethylene (HDPE), 30% (w/w) of Ethylene Vinyl Alcohol (EVOH), and 20% (w/w) of a maleic anhydride copolymer has been compounded in a twin screw extruder to obtain the compounded material composition in a pellet shape.

### Example 6

50% (w/w) of a High Density Polyethylene (HDPE), 30% (w/w) of Ethylene Vinyl Alcohol (EVOH), and 20% (w/w) of an ionomer has been compounded in a twin screw extruder to obtain the compounded material composition in a pellet shape.

Although the subject matter has been described in considerable detail with reference to certain preferred embodiments thereof, other embodiments are possible. As such, the spirit and scope of the disclosure should not be limited to the description of the preferred embodiment contained therein.

1. A material composition comprising:
50% to 60% (w/w) of a High Density Polyethylene (HDPE);
30% to 40% (w/w) of Ethylene Vinyl Alcohol (EVOH); and
10% to 20% (w/w) of at least one compatibilizer;
wherein the material composition comprises flake-shaped particles.

2. The material composition as claimed in claim 1, wherein the compatibilizer is selected from an ionomer or a maleic anhydride copolymer.

3. A laminate tube comprising:
a body portion;
a neck portion; and
a tube shoulder;
wherein the tube shoulder is made up of a material composition comprising:
50% to 60% (w/w) of a High Density Polyethylene (HDPE);
30% to 40% (w/w) of Ethylene Vinyl Alcohol (EVOH); and
10% to 20% (w/w) of at least one compatibilizer;
wherein the material composition comprises flake-shaped particles.

4. The laminate tube as claimed in claim3, wherein the body portion and the neck portion are each independently made up of a material composition comprising:
50% to 60% (w/w) of a High Density Polyethylene (HDPE);
30% to 40% (w/w) of Ethylene Vinyl Alcohol (EVOH); and
10% to 20% (w/w) of at least one compatibilizer;
wherein the material composition comprises flake-shaped particles.

5. The laminate tube as claimed in claim 3, wherein the compatiblizer is selected from an ionomer or a maleic anhydride copolymer.

6. The laminate tube as claimed in claim 3, wherein the tube shoulder further comprises an inner barrier liner which is mounted internally in the tube shoulder.

7. The laminate tube as claimed in claim 6, wherein the inner barrier liner comprises of:
at least one polyolefin layer made up of simple olefin selected from polyethylene or polypropylene;
at least one barrier layer made up of a material selected from aluminium foil or EVOH; and
at least one tie layer made up of a material selected from a acid copolymer or maleic anhydride grafted copolymer present between the polyolefin layer and the barrier layer.

8. The laminate as claimed in claim 7, wherein the polyolefin layer has a thickness in the range of 40 microns to 100 microns.

9. The laminate as claimed in claim 7, wherein the barrier layer has a thickness in the range of 10 to 25 microns.

10. The laminate as claimed in claim 7, wherein the tie layer has a thickness in the range of 20 to 50 microns.

11. The laminate tube as claimed in claim 6, wherein the inner liner comprising of:
an outer polyolefin layer having thickness of 40 microns;
a barrier layer having thickness of 20 microns;
a first tie layer binding the outer polyolefin layer and the barrier layer, having thickness of 25 microns;
an inner polyolefin layer having thickness of 50 microns; and
a second tie layer binding the inner polyolefin layer and the barrier layer, having thickness of 25 microns.
